(19) United States
(12) Patent Application Publication
(10) Pub. No.: US 2024/0086457 A1
(43) Pub. Date: Mar. 14, 2024

(54) ATTENTION AWARE MULTI-MODAL MODEL FOR CONTENT UNDERSTANDING

(71) Applicant: ADOBE INC., San Jose, CA (US)

(72) Inventors: Yaman KUMAR, New Delhi (IN); Vaibhav AHLAWAT, Bangalore (IN); Ruiyi ZHANG, San Jose, CA (US); Milan AGGARWAL, Delhi (IN); Ganesh Karbhari PALWE, Bangalore (IN); Balaji KRISHNAMURTHY, Noida (IN); Varun KHURANA, New Delhi (IN)

(21) Appl. No.: 17/944,502

(22) Filed: Sep. 14, 2022

(51) Int. Cl. G06F 16/58; G06F 16/55

(52) U.S. Cl. CPC G06F 16/58; G06F 16/55

(57) ABSTRACT

A content analysis system provides content understanding for a content item using an attention aware multi-modal model. Given a content item, feature extractors extract features from content components of the content item in which the content components comprise multiple modalities. A cross-modal attention encoder of the attention aware multi-modal model generates an embedding of the content item using features extracted from the content components. A decoder of the attention aware multi-modal model generates an action-reason statement using the embedding of the content item from the cross-modal attention encoder.

### BACKGROUND

Most work in artificial intelligence for visual content has focused on natural images, such as images captured using a camera. The natural images generally capture a scene showing a state of the world at a point in time and do not use any rhetorical devices. In contrast to natural images, some visual content items (e.g., marketing content such as advertisements) are intended to convey meaning using rhetorical devices, such as, for instance, emotions, symbolism, slogans, and text messages. However, conventional artificial intelligence approaches used on natural images are not well suited for understanding the meaning conveyed by such content items.

### SUMMARY

Some aspects of the present technology relate to, among other things, an attention aware multi-modal model that performs content understanding for content items. Given a content item, features are extracted from different content components of the content item. The content components comprise different modalities, such as image-based, text-based, and/or symbol-based modalities. The attention aware multi-modal model includes a cross-modal attention encoder that generates an embedding for the content item using the features extracted from the content components. The cross-modal attention encoder generates the embedding for the content item by accounting for interdependencies between the different modalities of the content components. The attention aware multi-modal model also includes a decoder that generates an action-reason statement for the content item using the embedding for the content item provided by the cross-modal attention model. The decoder can comprise a text generation model trained to generate text of action-reason statements for content items.

In some configurations, one modality for which features are extracted for the content item comprises actual gaze patterns. In other configurations, an attention pattern for the content item serves as a proxy for an actual gaze pattern on the content item. In such configurations, a generator network is trained to generate an attention pattern for the content network using generated gaze patterns for the content item. In some aspects, adversarial training is used to train the generator network to provide the attention pattern for the content item. In further configurations, other user interaction data with the content item (e.g., touch, scroll, click, eye scanpaths, etc.) is employed instead of or in addition to actual or generated gaze patterns.

In further configurations, the attention aware multi-modal model also determines one or more topics and/or one or more sentiments for the content item. The topic(s) and sentiment(s) can be determined by adding attention layers to the cross-modal attention model and applying classifiers to outputs of the additional attention layers. The identified topic(s) and/or sentiment(s) are used by the decoder in some configurations when generating the action-reason statement for the content item.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram illustrating generation of an action-reason statement from a content item using an attention aware multi-modal model in accordance with some implementations of the present disclosure;

FIG. 3 is a diagram illustrating attention maps generated using a Visual Transformer (ViT) model trained in accordance with some implementations of the present disclosure;

FIG. 4 is a block diagram illustrating generation of an action-reason statement from a content item using an attention aware multi-modal model in accordance with some implementations of the present disclosure;

FIG. 5 is a diagram illustrating ground truth and predicted action-reason statements, topics, and sentiments for content items in accordance with some implementations of the present disclosure;

FIG. 6 is a flow diagram showing a method for performing content understanding for a content item using an attention aware multi-modal model in accordance with some implementations of the present disclosure;

FIG. 7 is a flow diagram showing a method for training a generator network to generate an attention map for a content item in accordance with some implementations of the present disclosure; and

FIG. 8 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “content item” refers to a visual unit of information intended to convey meaning to a viewer. A content item combines multiple visual components, such as images and text, to convey meaning. For instance, in some aspects, a content item comprises an advertisement or other marketing message with images, text, and/or other visual components.

A “content component” refers a portion of a content item. Each content component can comprise a different modality. By way of example only and not limitation, content components of a content item can comprise an image of the entire content item, image objects from within the content item (e.g., regions of interest in the content item), captions describing portions of the content item, symbols in the content item, and text in the content item.

As used herein, an “action-reason statement” for a content item comprises text indicating an action that the content item intends a viewer to take and a reason for the viewer to take the action.

A “feature extractor” comprises one or more models (such as neural network-based models) that extract features from a content component. A feature extractor encodes extracted features in an embedding. By way of example, a feature extractor can be an image-based model, such as a Visual Transformer (ViT) model, or a language model, such as a such as a Bidirectional Encoder Representations from Transformers (BERT) model

A “cross-modal attention encoder” in accordance with some aspects of the technology described herein comprises a model (e.g., a neural network-based model) that generates an embedding for a content item using embeddings from feature extractors encoding features extracted for content components of the content item. In some aspects, the cross-modal attention encoder employs attention masks from one modality to highlight extracted features in another modality to thereby link and extract common features across multiple modalities.

A “decoder” in accordance with some aspects of the technology described herein comprises a text generation model (e.g., a neural network-based model) that generates text for an action-reason statement given an embedding of an item from a cross-modal attention encoder.

A “customer attention network” in accordance with some aspects of the technology described herein comprises an adversarial model (e.g., a neural network-based model) that employs a discriminator network to train a generator network to generate an attention map for a content item as a proxy for actual gaze patterns.

### Overview

Some previous work has attempted to use artificial intelligence to understand content items by identifying action-reason statements indicating actions the content items are intended to convey and the reasons for the actions. However, the previous work treated action-reason as a retrieval or ranking task from a small candidate set (<20 size) from which an action-reason statement can be recovered for understanding a content item. The previous work trained a model with the objective of ranking the ground truth statement higher than other statements in the candidate set that act as negatives. However, such a problem configuration exhibits some fundamental shortcomings. The assumption about the existence of a candidate set of action-reason statements by the previous literature is impractical. Content items often exist in highly creative spaces with new innovative strategies appearing daily. In this rapidly changing setting, it is infeasible to limit to a candidate set.

Another shortcoming of existing artificial intelligence techniques with respect to content understanding is that although eye tracking has been used in marketing science for more than 100 years, deep learning methods have not yet adopted it. Getting eye movements data is extremely challenging. Eye tracking is slow and expensive to collect and process, has customer privacy issues, and requires the support of specialized equipment. Moreover, the size of training sets used in artificial intelligence is typically prohibitively high for recording human eye-tracking signals. Due to these reasons, despite having considerable amount of signal for marketing, integration of eye tracking in artificial intelligence-based applications has seen limited work. This is also the case for other types of user inputs with items, such as touch and mouse inputs over an item.

Aspects of the technology described herein improve the functioning of the computer itself in light of these shortcomings in existing technologies by providing an attention aware multi-modal model for performing content understanding on a content item. Instead of retrieving action-reason statements from a candidate set, the attention aware multi-modal model generates action-reason statements for content items. Additionally, in some aspects, the attention aware multi-modal model leverages generated eye movements over content items as part of the content understanding process.

In accordance with some aspects, given a content item, features are extracted from content components of the content item. The content components comprise multiple modalities, such as image-based, text-based, and/or symbol-based modalities. By way of example only and not limitation, the content components of a content item can include an image of the overall content item, image objects from portions of the content item, captions for portions of the content item, symbols identified in the content item, and text in the content item. Different types of feature extractors are employed to extract features based on the different modalities of the content components.

In some configurations, actual or generated gaze patterns are used to extract features for one modality of the content item. Actual gaze patterns are based on tracking eye movements of individuals viewing the content item. Given the difficulty of obtaining actual gaze patterns, some aspects of the technology described herein employ generated eye movements instead of tracked eye movements. In some configurations, a generator network generates attention patterns for the content item as a proxy for actual gaze patterns. In some cases, the generator network is trained to generate an attention pattern for a content item using adversarial training. In further configurations, other user interaction data with the content item (e.g., touch, scroll, click, eye scanpaths, etc.) is employed instead of or in addition to actual or generated gaze patterns.

Features extracted from content components of the content item are provided as input to a cross-modal attention encoder, which generates an embedding for the content item. In some instances, a feature embedding is provided for each content component, the feature embeddings are concatenated, and the cross-modal attention encoder generates the embedding for the content item using the concatenated embeddings. The cross-modal attention encoder generates the embedding for the content item by accounting for interdependencies among the different modalities. For instance, attention masks from one modality (e.g. text) can be used to highlight extracted features in another modality (e.g. symbolism).

Using the embedding for the content item from the cross-modal attention encoder, a decoder generates an action-reason statement for the content item. The action-reason statement provides an indication of an action the content item intends to convey and a reason for that action. The decoder comprises a text generation model that is trained to generate text for an action-reason statement for content items.

In some configurations, the attention aware multi-modal model also identifies topics and sentiments associated with the content item. For instance, some aspects add a topic attention layer to the cross-modal attention encoder, and a topic classifier identifies one or more topics from output of the topic attention layer. In some aspects, a sentiment attention layer is added to the cross-modal attention encoder, and a sentiment classifier identifies one or more sentiments from output of the sentiment attention layer. The topic(s) and/or sentiment(s) can also be provided to the decoder for use in generating the action-reason statement.

Aspects of the technology described herein provide a number of improvements over existing technologies. For instance, the technology generates action-reason statements for content items, as opposed to prior works that performed a retrieval task that includes selection from a set of pre-existing action-reason statements. By approaching the problem as a generation task (as opposed to a retrieval task in previous works), the technology described herein is able to generate action-reason statements that accurately capture the meaning of content items. Additionally, use of cross-modal attention for different components of a content item enables an understanding of interdependencies between the various modalities, thereby providing qualitatively and quantitatively improved results. Further, some aspects employ generated gaze patterns (or other user interaction data with an, such as touch, scroll, and/or click inputs), thereby solving the problem of lack of actual gaze patterns from tracking eye movements and also providing state-of-the-art results. Features extracted using such generated gaze patterns when employed with textual, symbolism, and/or knowledge-based embeddings provide a rich feature space for the downstream task of decoding what and why of content items, as well as predicting sentiments and topics.

### Example System for an Attention Aware Multi-Modal Model for Content Understanding

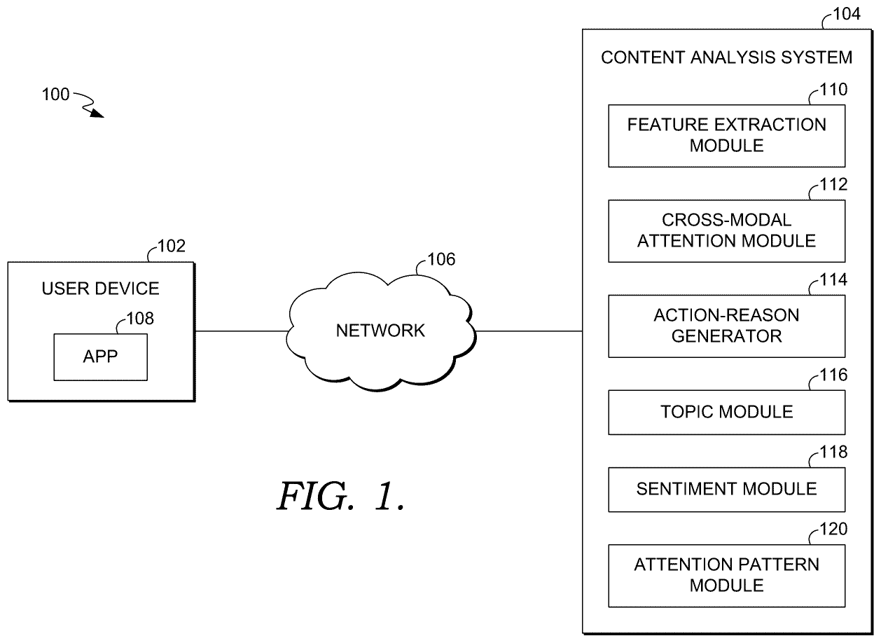

With reference now to the drawings, FIG. 1 is a block diagram illustrating an exemplary system 100 for performing content understanding using an attention aware multi-modal model in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

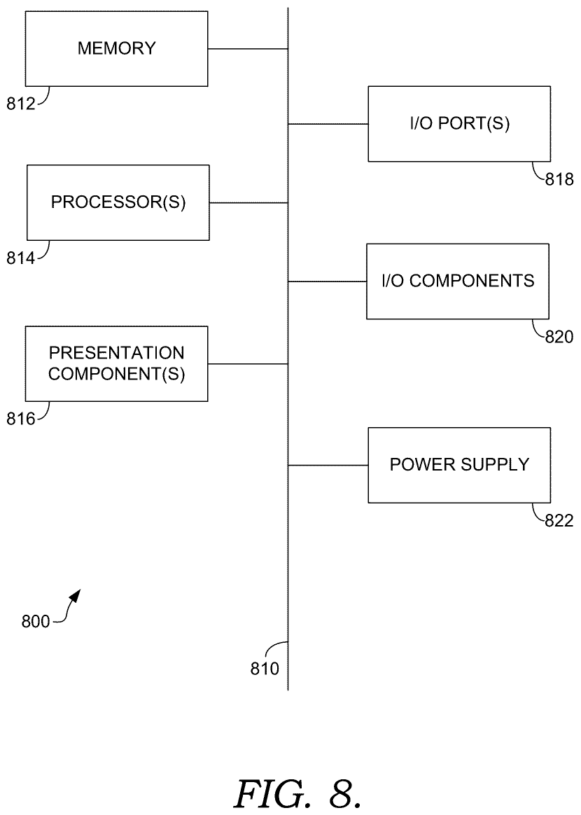

The system 100 is an example of a suitable architecture for implementing certain aspects of the present disclosure. Among other components not shown, the system 100 includes a user device 102 and a content analysis system 104. Each of the user device 102 and content analysis system 104 shown in FIG. 1 can comprise one or more computer devices, such as the computing device 800 of FIG. 8, discussed below. As shown in FIG. 1, the user device 102 and the content analysis system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of user devices and server devices can be employed within the system 100 within the scope of the present technology. Each can comprise a single device or multiple devices cooperating in a distributed environment. For instance, the content analysis system 104 could be provided by multiple server devices collectively providing the functionality of the content analysis system 104 as described herein. Additionally, other components not shown can also be included within the network environment.

The user device 102 can be a client device on the client-side of operating environment 100, while the content analysis system 104 can be on the server-side of operating environment 100. The content analysis system 104 can comprise server-side software designed to work in conjunction with client-side software on the user device 102 so as to implement any combination of the features and functionalities discussed in the present disclosure. For instance, the user device 102 can include an application 108 for interacting with the content analysis system 104. The application 108 can be, for instance, a web browser or a dedicated application for providing functions, such as those described herein. Among other things, the application 108 can provide one or more user interfaces for interacting with the content analysis system 104, for instance to allow a user to identify contents items for content understanding tasks and to present action-reason statements, topics, and/or sentiments generated for content items by the content analysis system 104.

This division of operating environment 100 is provided to illustrate one example of a suitable environment, and there is no requirement for each implementation that any combination of the user device 102 and the content analysis system 104 remain as separate entities. While the operating environment 100 illustrates a configuration in a networked environment with a separate user device and content analysis system, it should be understood that other configurations can be employed in which components are combined. For instance, in some configurations, a user device can also provide content analysis capabilities.

The user device 102 comprises any type of computing device capable of use by a user. For example, in one aspect, the user device comprises the type of computing device 800 described in relation to FIG. 8 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user can be associated with the user device 102 and can interact with the content analysis system 104 via the user device 102.

At a high level, the content analysis system 104 performs content understanding on content items using an attention aware multi-modal model. Given a content item, the content analysis system 104 uses one or more feature extractors to extract features from content components of the content item, where the content components comprise different modalities. Embeddings encoding the extracted features from the content components are provided to a cross-modal attention encoder of the attention aware multi-modal model. The cross-modal attention encoder generates an embedding for the content item that captures the interdependencies of the multiple modalities of the content components. A decoder of the attention aware multi-modal model uses the embedding for the content item to generate text for an action-reason statement. In some aspects, the attention aware multi-modal model also identifies topics and sentiments of the content item.

As shown in FIG. 1, the content analysis system 104 includes a feature extraction module 110, a cross-modal attention module 112, an action-reason generator 114, a topic module 116, a sentiment module 118, and an attention pattern module 120. The components of the content analysis system 104 can be in addition to other components that provide further additional functions beyond the features described herein. The content analysis system 104 can be implemented using one or more server devices, one or more platforms with corresponding application programming interfaces, cloud infrastructure, and the like. While the content analysis system 104 is shown separate from the user device 102 in the configuration of FIG. 1, it should be understood that in other configurations, some or all of the functions of the content analysis system 104 can be provided on the user device 102.

In one aspect, the functions performed by components of the content analysis system 104 are associated with one or more applications, services, or routines. In particular, such applications, services, or routines can operate on one or more user devices, servers, can be distributed across one or more user devices and servers, or be implemented in the cloud. Moreover, in some aspects, these components of the content analysis system 104 can be distributed across a network, including one or more servers and client devices, in the cloud, and/or can reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

Given a content item for analysis, the feature extraction module 110 extracts features from different content components of the content item. More particularly, the content item comprises content components in different modalities, including image-based, text-based, and/or symbolism-based modalities. As such, the feature extraction module 110 comprises various types of feature extractors for extracting features from the different modalities. By way of example only and not limitation, the types of content components of the content item from which the feature extraction module 110 can extract features include: an image of the overall content item, image objects within the content item (e.g., regions of interest); captions determined from portions of the content item; symbols identified from portions of the content item; and text within the content item.

In some aspects, the entire content item is treated as an image-based content component for feature extraction. Different types of image-based feature extractors can be employed by the feature extraction module 110 for extracting features from the image of the overall content item. The feature extractors can extract features based on visual saliency and/or importance associated with different regions of the content item. By way of example only and not limitation, models such as a Vision Transformer (ViT) model or a Unified Model for Visual Saliency and Importance (UMSI) can be employed to extract features from the image of the overall content item. In some configurations, the features extracted for the image of the overall content item are based on gaze patterns associated with the content item. In instances in which eye tracking has been performed on users viewing the content item, the features can be extracted based on actual gaze patterns from the eye tracking. In other instances, attentions patterns are generated by one or more models using generated gaze patterns, and features are extracted based on the attention patterns. The attention patterns essentially serve as a proxy for actual gaze patterns. Attention pattern generation will be described in further detail below. In further configurations, other user interaction data (e.g., touch, scroll, click, eye scanpaths, etc.) is employed instead of or in addition to actual or generated gaze patterns.

For image objects, in some aspects, the feature extraction module 110 employs an object detector model to detect and extract image objects as regions of interest from the content item. Different types of object detection models, such as the single-shot object detector model, can be employed to identify image objects in the content item. For captions, the feature extraction module 110 extracts captions describing portions of the content item using a caption model, such as the DenseCap model. For symbols, the feature extraction module 110 employs a symbol classifier to identify symbolic elements within the content item. For text, optical character recognition (OCR) is performed (as needed to identify text within the content item), and the feature extraction model employs a text-based model, such as a Bidirectional Encoder Representations from Transformers (BERT) model, to extract features from the text.

The feature extraction module 110 generates an embedding for each content component of the content item. Each embedding encodes the features extracted from a corresponding content component. The embeddings from the feature extraction module 110 are provided as input to the cross-modal attention module 112. To capture the interdependence of multiple modalities and generate more effective embeddings, the cross-modal attention module 112 applies a cross-modal attention encoder to the extracted features. The cross-modal attention encoder can comprise, for instance, a transformer encoder that performs cross modality fusion through its self-attention layers. Cross-modal attention is a novel fusion method in which attention masks from one modality (e.g. text) are used to highlight the extracted features in another modality (e.g. symbolism). It helps to link and extract common features in two or more modalities, since common elements exist across multiple modalities, which complete and reinforce the message conveyed by the content item. Cross-modal attention is also capable of generating effective representations in the case of missing or noisy data or annotations in one or more modalities. This is helpful in cases in which the content item uses implicit associations and relations to convey meaning. In some aspects, the embeddings from the feature extraction 110 are concatenated and provided as input to the cross-modal attention encoder, which outputs a combined embedding for the content item.

The embedding for the content item provided by the cross-modal attention encoder of the cross-modal attention module 112 is provided as input to the action-reason generator 114. Given the embedding for the content item, the action-reason generator 114 employs a text generation model (e.g., a transformer decoder) to generate an action-reason statement. The action-reason statement comprises text that identifies an action the content item is intending a user to take and a reason for taking the action.

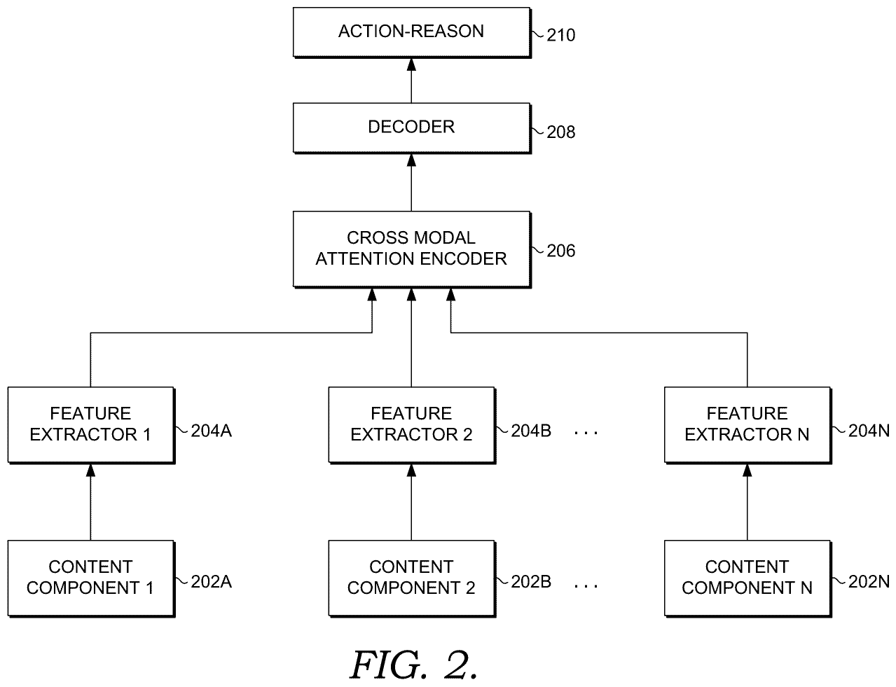

FIG. 2 provides a simplified block diagram illustrating generation of an action-reason statement by an attention aware multi-modal model in accordance with some aspects of the technology described herein (e.g., implemented via the feature extraction module 110, cross-modal attention module 112, and the action-reason generation module 114 of FIG. 1). As shown in FIG. 2, feature extractors 204A-204N extract features from corresponding content components 202A-202N. Any number of feature extractors can be employed for extracting features from any number of content components within the scope of the technology described herein. The content components 202A-202N can include different modalities, including, for instance, image-based, text-based, and/or symbol-based modalities. By way of example only and not limitation, the content components 202A-202N can include an image of the entire content item, image objects from regions of interest in the content item, captions determined for portions of the content item; symbols determined from the content item, and/or text from the content item. Some features can be extracted from actual gaze patterns, generated gaze patterns, and/or user inputs (e.g., touch, scroll, click inputs from users interacting with the content item) associated with the content item. Other forms of content components of the content item can be employed with the scope of aspects of the technology described herein.

The features extracted from each of the content components 202A-202N by the feature extractors 204A-204N can comprise feature embeddings. The feature embeddings are provided as input to a cross-modal attention encoder 206. For instance, the feature embeddings can be concatenated and the concatenated embeddings provided as input to the cross-modal attention encoder 206. Given the extracted features encoded by the embeddings, the cross-modal attention encoder 206 generates an embedding representing the content item. The embedding representing the content item provided by the cross-modal attention encoder 206 is provided as input to a decoder 208. The decoder 208 comprises a text generation model that generates an action-reason statement 210 given the embedding of the content item from the cross-modal attention encoder 206.

In some configurations, a content analysis system employs the attention aware multi-modal model for topic and/or sentiment identification for a content item. With reference again to FIG. 1, the content analysis system 104 includes a topic module 116 and a sentiment module 118. For the detection of sentiment and topics, branches are added to the cross-modal attention encoder. For instance, in some aspects, a first attention layer is used for topic detection (i.e., a topic attention layer), and another attention layer is used for sentiment detection (i.e., sentiment attention layer). The topic module 116 applies a topic classifier to the output of the topic attention layer to identify one or more topics for the content item. The sentiment module 118 applies a sentiment classifier to the output of the sentiment attention layer to identify one or more sentiments associated with the content item. In some configurations, the identified topic(s) and/or sentiment(s) are provided as input to the text generator model of the action-reason generator 114 for use in generating the action-reason statement.

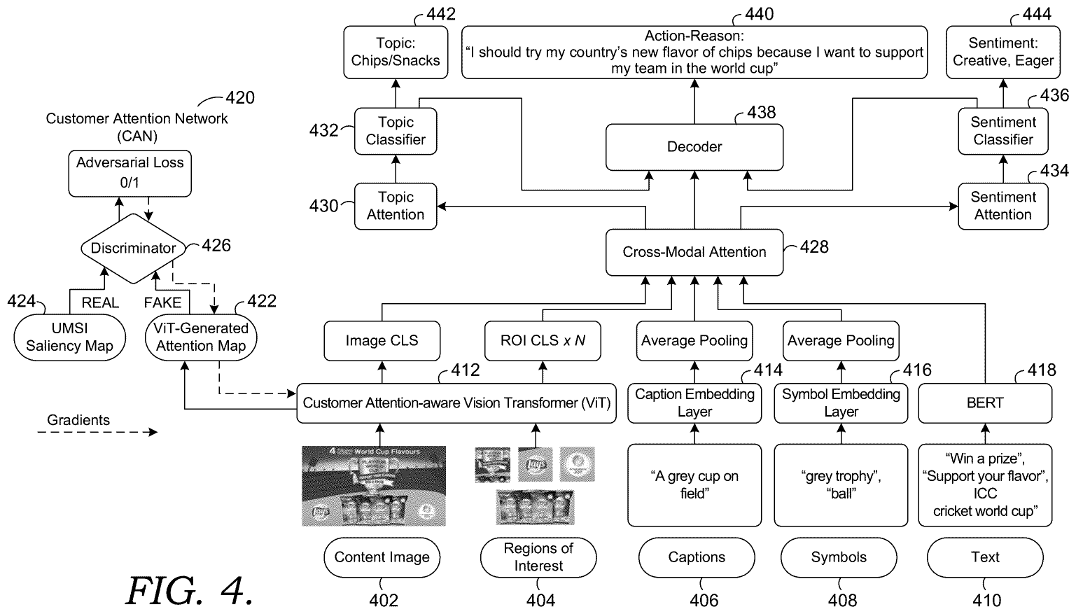

As previously indicated, in some configurations, the attention aware multi-modal model extracts features for an image of the overall content item using attention patterns as a proxy for actual gaze patterns. Accordingly, as shown in FIG. 1, the content analysis system 104 includes an attention pattern module 120 that generates an attention pattern for the overall content item with the attention pattern serving as a proxy for actual gaze patterns. The attention pattern module 120 employs adversarial training to train a generator model to generate an attention pattern for the content item. In some configurations, the generator model comprises a Vision Transformer (ViT) model. The adversarial training employs a discriminator network that differentiates between attention patterns generated by the generator network (considered to be “fake” patterns) and saliency patterns generated by a saliency model (considered to be “real” patterns). In some conformation, the saliency model comprises a Unified Model for Visual Saliency and Importance (UMSI) model. Parameters (e.g., weights) of the generator network and discriminator network are updated over multiple iterations using a loss function based on the generator network's ability to generate attention patterns that appear real to the discriminator network, and the discriminator network's ability to identify attention patterns from the generator as “fake” patterns. Additional details regarding generation of attention patents using adversarial training in accordance with some aspects are provided below with reference to FIG. 4.

The ViT model has shown impressive performance gains over computer vision tasks over natural images. However, because some content items are very different from natural images in the way the content items convey meaning, the ViT model's learned attention patterns can be suboptimal for such content items. In addition, training a ViT model from scratch on such content items is generally infeasible due to a lack of large datasets (ViT was trained on 14 million images and then fine-tuned on another 1 million images). To solve this problem and still retain the power of a pre-trained ViT model, some aspects adjust a ViT model's learned attention patterns to align better with human saliency patterns to provide better performance. In some configurations, generated gaze patterns are used to fine-tune the attention patterns of a ViT model, thereby retaining the predictive power of natural-image trained ViT and also adapting it suitably for content items that are intended to convey meaning. As noted above, some aspects employ the UMSI model to generate gaze patterns on content items. A UMSI model learns to predict visual importance in input graphic designs, and saliency in natural images. Unlike saliency or visual flow, which model eye fixations and trajectories, respectively, importance identifies design elements of interest/relevance to the viewer. UMSI generates visual importance for content items.

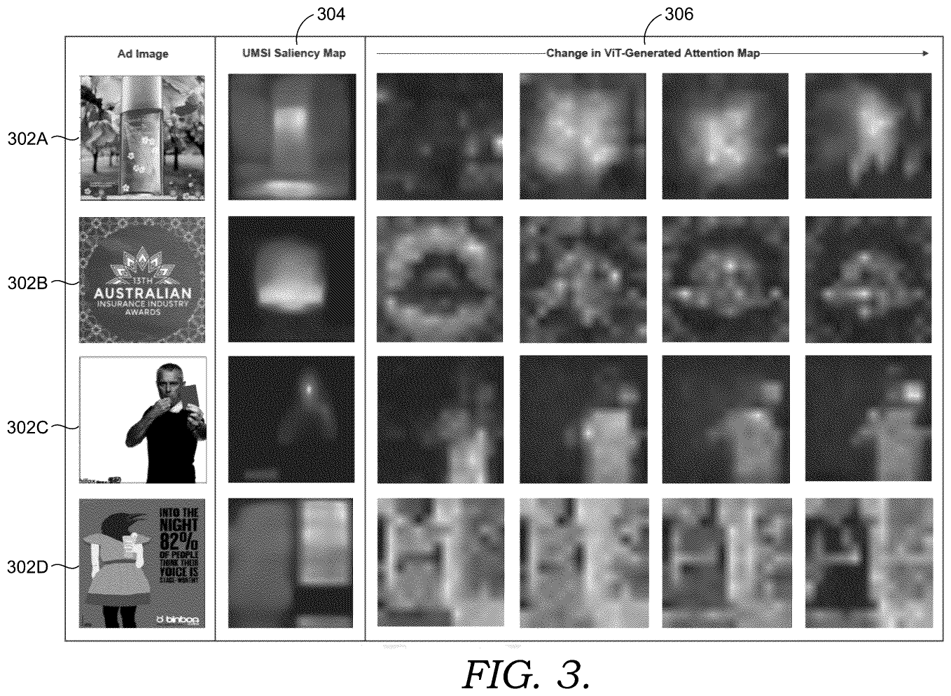

FIG. 3 provides examples of attention patterns generated for content items using adversarial training in accordance with some aspects of the technology described herein. Each row of FIG. 3 corresponds with an ad image (i.e., ad images 302A-302D). For a given ad image, a ViT model was trained to generate an attention map to serve as a proxy for gaze patterns. In particular, an adversarial training process was used in which the ViT model was updated over a number of iterations based on a discriminator network judging whether a saliency map from a UMSI model (as shown by column 304) and an attention map from the ViT model are real or fake. At 306, a progression of attention patterns generated by the ViT model over multiple iterations is shown for each of the ad images 302A-302D.

With reference now to FIG. 4, a block diagram is provided that illustrates operation of an attention aware multi-modal model processing a content item in accordance with some aspects of the present technology. The attention aware multimodal model includes a number of components, including: feature extractors 412, 414, 416, and 418 for extracting features from content components 402, 404, 406, 408 and 410; a customer attention network 420 providing a zero-sum game based on generator-discriminator model for generating gaze patterns; a cross-modal attention encoder 428 that encode features extracted from the multi-modal content components; a set of classifiers 432 and 436 that detect topics and sentiments of the content item; and a decoder 438 to generate an action-reason statement. Each will be described in further detail below.

Feature Extractors: The architecture of the attention aware multi-modal model includes feature extractors for the image, text, and symbolism modalities. Each of the feature extractors shown in FIG. 4 is described in further detail below. It should be understood that the feature extractors shown in FIG. 4 are provided by way of example only and not limitation. Other feature extractors can be employed and feature extractors shown in FIG. 4 can be omitted within the scope of aspects of the technology described herein.

Image Feature: The attention aware multi-modal model shown in FIG. 4 employs a Vision Transformer (ViT) model 412 for extracting image features from an image of the entire content item 402. Although a ViT model is shown in FIG. 4, it should be understood that other types of image/vision-based models can be employed. The ViT model 412 resizes the input image to size 224×224 and divides it into patches of size 16×16. The ViT model 412 used in some configurations can be pre-trained on an image dataset, such as the ImageNet 21 k dataset. The attention aware multi-modal model of FIG. 4 uses the first output embedding, which is the CLS token embedding, a 768 dimension tensor, that provides a representation of the entire image of the content item. Then, a fully connected layer can be used to reduce the size of the embedding, resulting in a dimension tensor of size 256.

In the configuration shown in FIG. 4, to make the ViT model 412 customer attention aware (i.e., provide features related to generated gaze patterns), the ViT model 412 is fine-tuned in an adversarial learning fashion using what is referred to herein as a customer attention network (CAN) 420. In particular, a zero-sum adversarial game is used to train the ViT model 412 with customer attention patterns. The game is played between two players (P1, P2) with one set of players being a generator network and the other being a discriminator network. Here, the ViT model 412 is the generator network, and the discriminator 426 is designed such that its task is to differentiate between attention patterns (e.g., the ViT-generated attention map 422) generated by the ViT model 412 and customer attention patterns (e.g., the UMSI saliency map 424) generated by a UMSI model. Although FIG. 4 provides an example in which a UMSI model is used, it should be understood that other types of saliency and/or importance models can be employed.

In some aspects, the customer attention network 420 is trained with minimax loss to minimize the following objective:

$${min}_{𝔾} {max}_{𝔻} {ℒ}_{𝒜𝒯} ( 𝔾 , 𝔻 ) = {𝔼}_{{g}_{g} \sim {G}_{g} ( x )} [ log ( 𝔻 ( {g}_{g} \vert x ) ) ] + {𝔼}_{{g}_{f} \sim {G}_{f} ( x )} [ log ( 1 - 𝔻 ( 𝔾 ( {g}_{f} \vert x ) ) ) ] \qquad ( 1 )$$

where g_{g} is the saliency map generated by the UMSI model (G_{g}), g_{f} is the attention map generated by the last layer of the ViT model 412 (G_{f}), x is the input image of the content item 402, and D is the discriminator 426 which discriminates between real and fake attention maps. The discriminator wants to maximize its payoff such that [symbol] (g_{g}|x) is close to 1, i.e. the saliency maps generated by the UMSI model are classified as real and the attention maps generated by the ViT model 412 are classified as fake, i.e. [symbol] ( [symbol] (g_{f}|x)) is close to zero. The generator (i.e., the ViT model 412) minimizes the objective such that [symbol] ( [symbol] (g_{f}|x)) is close to 1. In some aspects, the discriminator 426 includes two blocks, each comprising convolutional and max pooling layers, followed by a linear layer that uses a binary cross entropy loss function. FIG. 4 presents a configuration in which access to ground-truth attention obtained from humans (i.e., gaze patterns) is unavailable (e.g., since it is challenging to obtain real customer eye movements). However, it should be understood that in cases in which ground-truth attention obtained from humans is available, the ground truth attention can be used in the framework in lieu of using the ViT model 412 trained using the CAN 420.

Image Objects: One particular difference between creative and natural images is the presence of composing elements in creative image. Although natural images contain elements that occur naturally in the environment, elements in a creative image are deliberately chosen by the creator to create intentional impact and deliver some message. Therefore, some aspects of the technology described herein identify the composing elements of a content item to understand the intention of the creator and the message of the content item to the viewer. Image objects are detected and extracted as regions of interest (RoIs) 404 from the content item. In some configurations, for example, the RoIs are obtained by training an object detection model, such as the single-shot object detector model) on an image dataset, such as the COCO dataset. In some configurations, the top ten RoIs are extracted from a content item, and the final RoI embedding is a 10×256 dimension tensor.

Captions: For detecting important activity from the image of the content item, a caption embedding layer 414 extracts caption embeddings for captions 406 identified for portions of the content item. For instance, in some aspects, the DenseCap model is used to extract caption embeddings, providing a single 256 dimension embedding.

Symbolism: While the names of objects detected in a content item convey the names or literal meaning of the objects, creative images often also use objects for their symbolic and figurative meanings. For example, an upward-going arrow represents growth or the north direction or movement towards the upward direction depending on the context; similarly, a person with both hands pointing upward might mean danger (e.g., when a gun is pointed) or joy (e.g., during dancing). Accordingly, as shown in FIG. 4, to capture the symbolism behind prominent visual objects present in the content item, a symbol embedding layer 426 generates embeddings for symbols 408 in the content item. By way of example, in some aspects, a symbol classifier is used on the content item to find the distribution of the symbolic elements present and then convert the symbolic elements to a 256 dimension tensor.

Text: The text present in a content item presents useful information (e.g., in the context of an ad, the text can provided information about the brand such as product details, statistics, reasons to buy the product, and creative information in the form of slogans and jingles that the company wants its customers to remember). As such, text 410 (e.g., OCT text) is extracted from the content item. For instance, a text extraction model such as the Google Cloud Vision API can be used to perform text extraction. The extracted text is concatenated, and in some cases, the size is restricted (e.g., to 100 words). The text is passed through a BERT model 418 (although other language models can be employed), the final CLS embedding is used as the text features. Similar to image embeddings, a fully connected layer is used to convert embeddings to 256 dimension. The final embedding of the text is a tensor of dimension 100×256.

Cross-modal Attention Encoder: To capture the interdependence of multiple modalities and generate more effective embeddings, a cross-modal attention encoder 428 is applied to the features extracted by the feature extractors discussed above. Cross-modal attention is a novel fusion method in which attention masks from one modality (e.g. text) are used to highlight the extracted features in another modality (e.g. symbolism). This helps to link and extract common features in two or more modalities, since common elements exist across multiple modalities, which complete and reinforce the message conveyed in the content. As an example to illustrate, images of a silver cup, stadium and ball, words like “Australian”, “Pakistani”, and “World Cup” present in a content item link the idea of buying a product with supporting one's country's team in the World Cup. Cross attention is also capable of generating effective representations in the case of missing or noisy data or annotations in one or more modalities. This is helpful in cases in which a content item (e.g., marketing data) uses implicit associations and relations to convey meaning. For instance, the noisy moving shadow of a man in a content item can indicate speed.

The input to the cross-modal attention encoder 428 is constructed by concatenating the content image, RoI, caption, symbol, and text embeddings from the feature extractors. In some aspects, this results in a 114×256 dimension input to the cross-modal attention encoder 428, and the cross-modal attention encoder 428 includes two layers of transformer encoders with a hidden dimension size of 256. The output of the cross-modal attention encoder 428 provides a final combined embedding of the content item. Given image embeddings Eᵢ, RoI embeddings Eᵣ, text embeddings Eₒ, caption embeddings E_{c}, and symbol embeddings Eₛ, the output of the cross-attention layer Eₐₜₜ is as follows:

Enc(X)=CMA([Eᵢ(X),Eᵣ(X),Eₒ(X),E_{c}(X),Eₛ(X)]),

where [ . . . , . . . ] is the concatenation operation.

Action-Reason Generation: Given the embedding of the content item provided by the cross-modal attention encoder, a decoder 438 generates an action-reason statement 440 for the content item. In some aspects of the technology described herein, action-reason generation is considered as a problem of discrete token generation, which learns to generate a sentence Y^{g}=(y^{g}₁ . . . , y^{g}_{T}) of length T conditioned on content item X. Here, each yₜ is a token from vocabulary A. Pairs (X,Y) are used to train a text generation model to provide the decoder 438. Some aspects employ text generation, where Y^{g} is a sentence and each y^{g}ₜ is a word. Starting from an initial state so, an autoregressive model produces a sequence of states (s₁, . . . , s_{T}) given an input sentence-feature representation (e(y^{g}₁), . . . , e(y^{g}_{T})), where e (⋅) denotes a word embedding function mapping a token to its d-dimensional feature representation. The states are recursively updated with a function known as the cell: sₜ=h(sₜ₋₁,e(y^{g}ₜ)). Some implementations that can be employed include, for instance, Long Short-Term Memory (LSTM], Gated Recurrent Unit (GRU), and Transformer. In order to generate sentence Y^{g} from a (trained) model, the following operations are iteratively applied:

yₜ₊₁^{g}˜Multi(softmax(g(sₜ))), (2)

sₜ=h(sₜ₋₁,e(yₜ^{g})), (3)

where Multi(1,⋅) denotes one draw from a multinomial distribution. In conditional generation, s₀ is initialized with Enc(X), where Enc(⋅) encodes the relevant information from context, which is parameterized by θₛ. To train a model, maximize likelihood estimation (MLE) is employed via minimizing cross-entropy loss:

[symbol]

_{g}=− [symbol] [log P_{θ}_{₁}(Y^{g}|Enc(X))]. (4)

In accordance with some aspects, the decoder 438 comprises a transformer decoder for generating the action-reason statement 440. Some configurations use a 8 layer decoder with 8 head attention and a hidden dimension size of 256. The output of the cross-modal attention encoder 428 is passed to the decoder 438, which generates the action-reason statement 440. The action-reason statement 440 is generated token by token through the decoder 438. To train the decoder 438, each training content item in a training dataset contains multiple action-reason statement annotations. In each training epoch, one of the actin-reason statement annotations is selected at random as the ground truth and compared with the generated statement from the decoder 438. In some aspects, a cross-entropy loss is applied with a condition that padding tokens are ignored for training the model.

Sentiment and Topic Classification: The attention aware multi-modal model of FIG. 4 also provides for the detection of sentiment and topics. As shown in FIG. 4, two branches are added to the cross-modal attention encoder 428, including a topic attention layer 430 to facilitate topic detection and a sentiment attention layer 434 to facilitate for sentiment detection. Additionally, a topic classifier 432 is applied to output from the topic attention layer 430 to identify the topics 442. Similarly, a sentiment classifier 436 is applied to output from the sentiment attention layer 434 to identify the sentiments 444.

Some aspects employ fully connected layers along with dropout and batch normalization to classify sentiments, with the following loss used for training:

$${ℒ}_{s} = - 𝔼 {\sum }_{i = 1}^{{M}_{2}} [ {y}_{i}^{s} {P}_{{θ}_{2}} ( {y}_{i}^{s} \vert Enc ( X ) ) \qquad ( 5 )$$

$$+ ( 1 - {y}_{i}^{s} ) ( 1 - {P}_{{θ}_{2}} ( {y}_{i}^{s} \vert Enc ( X ) ) ) ] \qquad ( 6 )$$

Some aspects approach topic detection as a multi-class classification problem. Categorical cross-entropy loss is used for training (as shown below), and accuracy is used to evaluate the final model:

$${ℒ}_{t} = - {\sum }_{i = 1}^{{M}_{3}} {y}_{i}^{t} log [ {P}_{{θ}_{2}} ( {y}_{i}^{t} \vert Enc ( X ) ) ] \qquad ( X ) ) ]$$

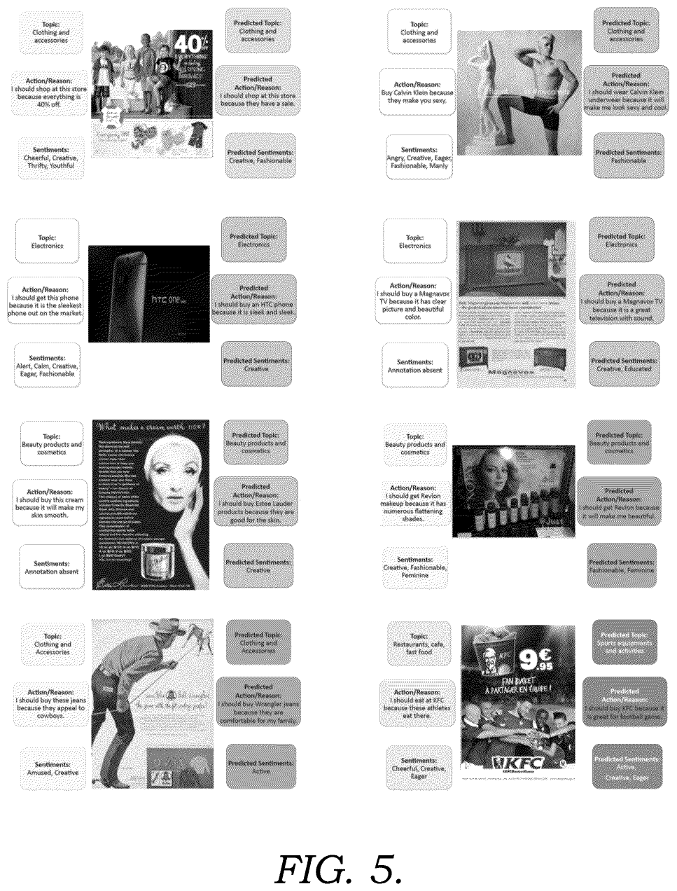

FIG. 5 provides examples of action-reason statements, topics, and sentiments predicted for each of a number of different content items by an attention aware multi-modal model in accordance with some aspects of the technology described herein. In particular, to the left of each content item is shown ground truth action-reason statements, topics, and sentiments used to train the model. To the right of each content item is shown predicted action-reason statements, topics, and sentiments generated by the trained model. The generated action-reason statements, topics, and sentiments predicted for each item could be presented to a user via a user interface.

### Example Methods for Content Understanding Using an Attention Aware Multi-Modal Model

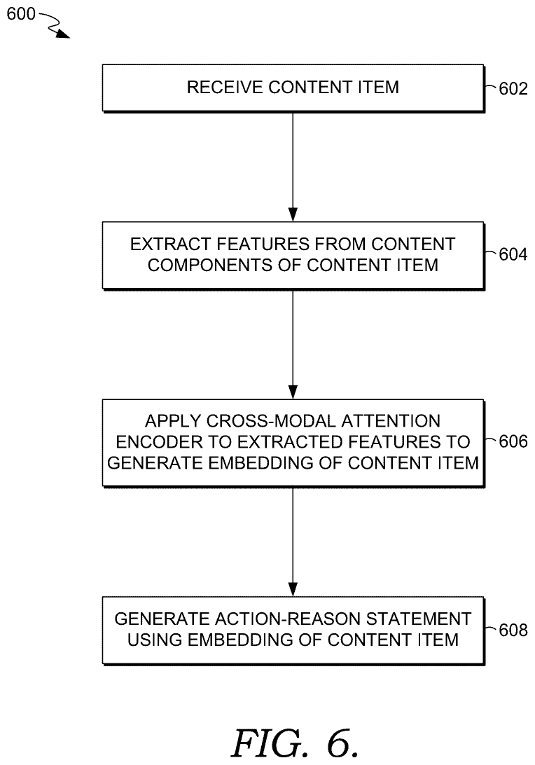

With reference now to FIG. 6, a flow diagram is provided that illustrates a method 600 for performing content understanding for a content item using an attention aware multi-modal model. The method 600 can be performed, for instance, by the content analysis system 104 of FIG. 1. Each block of the method 600 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

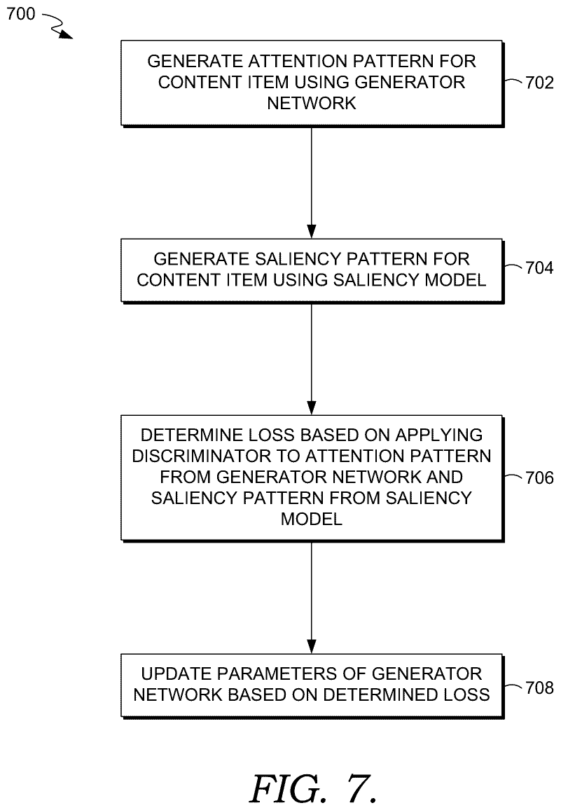

As shown at block 602, a content item is received. Features are extracted from content components of the content item, as shown at block 604. The content components comprise multiple modalities, and can include, for instance, an image of the overall content item, image objects from within the content item (e.g., regions of interest in the content item), captions describing portions of the content item, symbols in the content item, and text in the content item. The features are extracted from each content component using a feature extractor corresponding to the modality of the content component. In some instances, features are extracted for an image of the content item based on gaze patterns from eye tracking performed on users viewing the content item. In some instances, features are extracted from an attention pattern from a generator network. In some aspects, the generator network is trained using adversarial training (e.g., using the method 700 described below with reference to FIG. 7). In some aspects, features are extracted based on user inputs, such as, for example, touch, scroll, and click inputs, from users interacting with the content item.

A cross-modal attention encoder is applied to features extracted from the content components to generate an embedding of content item, as shown at block 606. In some instances, an embedding is generated for each content component at block 604, the content component embeddings are concatenated, and the concatenated embeddings are provided as input to the cross-modal attention encoder. The cross-modal attention encoder uses attention masks from one modality to highlight extracted features in another modality to encode the interdependence of features extracted from the multiple modalities of the content components.

As shown at block 608, an action-reason statement is generated by a decoder using the embedding of the content item from the cross-modal attention encoder. The decoder comprises a text generation model trained to generate the text of the action-reason statement given the embedding of the content item. In some configurations, topics and/or sentiments are determined for the content item (e.g., using classifiers on output from layers of the cross-modal attention encoder), and the topics and/or sentiments are used by the encoder when generating the action-reasons statement.

FIG. 7 provides a flow diagram illustrating a method 700 for training a generator network to generate an attention map for a content item. As noted above, an attention map for a content item can serve as a proxy for actual gaze patterns, thereby providing features from one modality for the content item. The method 700 can be performed over multiple iterations to train the generator network to provide an attention map for the content item. As shown at block 702, a preliminary attention pattern is generated for the content item using the generator network. The generation network can comprise, for instance, a ViT model. As shown 704 a saliency pattern is generated for the content item using a saliency model. The saliency model can comprise, for instance, a UMSI model.

A loss is determined at block 706 based on applying a discriminator network to the attention pattern from the generator network and the saliency pattern from the saliency model. In particular, the discriminator network determines whether each of the attention pattern and the saliency pattern is “real” or “fake”. The loss is determined using a loss function that causes the generator network to generate attention patterns that the discriminator network determines to be real, while causing the discriminator network to determine the saliency pattern as real and the attention patterns as fake. At each iteration, parameters (e.g., weights) of the generator network are updated based on determined loss, as shown at block 708. Parameters of the discriminator network can also be updated based on the determined loss.

### Experiment Results

The following discusses details of models built and trained using some aspects of the technology described herein. Also discussed are quantitative and qualitative results comparing models using the technology described herein with other models. Finally, an ablation study demonstrates contribution of different parts of the architecture.

A ViT model was trained on ImageNet-21 k images, and fine-tuned on advertisement images by adversarial training. Attention maps were resized to 224×224. For aligning the ViT model's attention patterns with customer attention, the last three transformer blocks of the ViT model were trained freezing the initial ones. UMSI saliency maps were treated as real distribution, and ViT-generated attention maps were treated as fake distribution. The discriminator classified attention maps as real or fake. The goal of the ViT model was to maximally fool the discriminator. The Adam optimizer was used to minimize the adversarial loss. The batch size was set to 16 and learning rate was initialized to 0.01.

The fine-tuned ViT model was used to extract the visual and RoI features from images. The OCR text was embedded using a BERT-based encoder. A model using a framework as described herein was trained to generate action-reason statements for 300 epochs with a batch size of 128 and a learning rate of 0.001 using the Adam optimizer. While generating action-reason statements during inference, the decoder was limited to generating a maximum of 15 tokens. To extend the model to predict the topic and sentiment of a content item, the model was trained on generating the action-reason task followed by adding the topic and sentiment classification loss to the generation loss.

The ADVISE model by Ye and Kovashka (described in Keren Ye and Adriana Kovashka. 2018. Advise: Symbolism and external knowledge for decoding advertisements. In Proceedings of the European Conference on Computer Vision (ECCV). 837-855) and the framework described herein without customer attention aware features were used as baselines for the tasks. Both models were trained for a similar number of epochs with a batch size of 128 and a learning rate of 0.001 using Adam optimizer. Since the ADVISE model treats the action-reason task as a ranking task, an LSTM-based decoder was trained to generate the statements. This modified model served as the baseline for the action-reason task.

Evaluation metrics for the three tasks: The performance of the framework described herein on action-reason generation was evaluated using multiple metrics commonly used to evaluate generation tasks such as BLEUk, METEOR, ROUGE, CIDER, and SPICE. The COCO evaluation toolkit was used for calculating the results. A comparison was also performed between the framework described herein with the action-reason ranking task by the ADVISE model. To evaluate topic predictions, accuracy was used as the target metric. Sentiment prediction, similar was modeled as a multi-label classification task and use accuracy, precision, recall, and F1-score for a thorough evaluation. Further, to compare the framework described herein with prior works that model sentiment prediction as a single label task, top-1 and top-5 accuracy were also computed.

Action-Reason Generation: For the generation of action-reason statements, five models were compared: 1) the baseline generation model based on ADVISE, 2) the framework described herein without cross-modal attention (CMA) layers, 3) the framework described herein with CMA, 4) the framework described herein without CMA but with Customer Attention Network (CAN), and 5) the framework described herein with CMA and CAN. A comparison of the generation results is shown in Table 1 and the ranking results is shown in Table 2. As can be seen from the tables, the framework described herein exceeds previous benchmarks in all the generation and classification metrics.

TABLE 1
Comparison of Action-Reason Generation Results

| Model | BLEU-1 | BLEU-2 | BLEU-3 | BLEU-4 | METEOR | ROUGE | CIDER | SPICE |
|---|---|---|---|---|---|---|---|---|
| ADVISE + LSTM | 35.1 | 21.5 | 12.8 | 7.2 | 18.7 | 33.8 | 5.9 | 2.6 |
| Framework w/o CMA | 53.5 | 41.9 | 32.6 | 24.7 | 26.0 | 48.0 | 38.9 | 8.4 |
| Framework w/o CMA + CAN | 53.9 | 42.2 | 32.7 | 24.8 | 26.2 | 48.7 | 42.2 | 8.9 |
| Framework with CMA | 54.7 | 42.8 | 33.4 | 25.4 | 26.9 | 49.4 | 48.9 | 9.6 |
| Framework with CMA + CAN | 54.9 | 43.1 | 33.9 | 26.2 | 27.0 | 49.8 | 54.2 | 10.7 |

TABLE 2
Comparison of Ranking Results

| | | Min | Average | Median |
|---|---|---|---|---|
| Model | Accuracy | Rank | Rank | Rank |
| VSE++ | 0.6660 | 1.734 | 3.858 | 3.614 |
| VSE++ | 0.6602 | 1.748 | 3.75 | 3.556 |
| VSE++ | 0.6716 | 1.712 | 3.731 | 3.519 |
| ADVISE | 0.7284 | 1.554 | 3.552 | 3.311 |
| ADVISE + OCR Text | 0.847 | 1.282 | — | — |
| Framework with CMA + CAN | 0.9195 | 1.1263 | 2.7414 | 2.5017 |

Topic and Sentiment Classification: The framework described herein was also evaluated on topic and sentiment classification. The comparison of the framework described herein with the baseline model can be seen in Table 3 below. The framework described herein outperforms the previous benchmarks on both topic and sentiment detection as well.

TABLE 3
Topic and Sentiment Results

| | | Sentiment | | | | |
|---|---|---|---|---|---|---|
| | Topic | F1- | Top-1 | Top-5 | | |
| Model | Acc | score | Acc | Acc | Prec | Rec |
| ADVISE | 0.603 | — | 0.279 | — | — | — |
| Framework with CMA | 0.597 | 0.467 | — | 0.882 | 0.739 | 0.388 |
| Framework with CMA + | 0.616 | 0.478 | — | 0.889 | 0.747 | 0.396 |
| CAN | | | | | | |

Ablation Studies: To determine the contribution of each modality for the framework described herein, model instances were trained with individual modalities and the performance of the model instances were evaluated. For this, the input to the CMA layer is kept as a single input modality. The rest of the architecture and hyperparameters are kept identical to the original multi-modality setup. The results of this experiment are shown in the Table 4 and Table 5. From the tables, it is evident that using all the modalities gives the best performance for the three tasks. While most of the performance in the generation task is due to the presence of text extracted using OCR, the image modality had maximum information for topic and sentiment detection. As opposed to natural images, symbolism in images contributes to inferring the topic and sentiment in advertisements; this is also evident from the results.

TABLE 4
Ablation Study for Generation Task - Different Modalities

| Model | BLEU-1 | BLEU-2 | BLEU-3 | BLEU-4 | METEOR | ROUGE | CIDER | SPICE |
|---|---|---|---|---|---|---|---|---|
| Image only | 49.8 | 38.0 | 27.9 | 18.9 | 23.6 | 43.3 | 8.1 | 3.7 |
| OCR only | 53.0 | 41.2 | 31.9 | 24.1 | 26.0 | 48.3 | 42.8 | 8.5 |
| Caption only | 51.7 | 39.6 | 29.7 | 21.6 | 23.9 | 44.8 | 14.6 | 4.2 |
| Symbol only | 47.6 | 36.3 | 27.1 | 19.7 | 23.3 | 45.3 | 10.3 | 3.4 |
| All features | 54.7 | 42.8 | 33.4 | 25.4 | 26.9 | 49.4 | 48.9 | 9.6 |

TABLE 5
Ablation Study for Topic and Sentiment - Different Modalities

| | | Sentiment | | |
|---|---|---|---|---|
| Model | Topic Acc | F1-score | Top-1 Acc | Top-5 Acc |
| Image only | 0.574 | 0.462 | 0.147 | 0.692 |
| OCR only | 0.328 | 0.357 | 0.097 | 0.659 |
| Caption only | 0.309 | 0.344 | 0.132 | 0.699 |
| Symbol only | 0.476 | 0.438 | 0.177 | 0.712 |
| All features | 0.616 | 0.467 | 0.401 | 0.807 |

### Exemplary Operating Environment

Having described implementations of the present disclosure, an exemplary operating environment in which embodiments of the present technology can be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what can be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory can be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which can be built in. Illustrative components include a microphone, joystick, game pad, satellite dish, scanner, printer, wireless device, etc. The I/O components 820 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 can be equipped with depth cameras, such as, stereoscopic camera systems, infrared camera systems, RGB camera systems, and combinations of these for gesture detection and recognition. Additionally, the computing device 800 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

1. A computer-implemented method comprising:
extracting features from a plurality of content components of a content item, the plurality of content components comprising a plurality of modalities;
applying a cross-modal attention encoder to the features extracted from the plurality of content components to generate an embedding of the content item; and
generating, by a decoder, an action-reason statement using the embedding of the content item.

2. The computer-implemented method of claim 1, wherein the plurality of content components comprise one or more selected from the following, an image of the content item, an image object, a caption, a symbol, and text.

3. The computer-implemented method of claim 1, wherein a first content component of the plurality of content components comprises at least one selected from the following: gaze patterns based on monitoring eye movements from users viewing the content item, and user inputs from users interacting with the content item.

4. The computer-implemented method of claim 1, wherein a first content component of the plurality of content components comprises an image of the content item, and wherein extracting features from the first content component comprises generating an attention pattern for the content item using a generator network trained using adversarial training.

5. The computer-implemented method of claim 4, wherein the generator network is trained by:
generating a preliminary attention pattern for the content item using the generator network;
generation a saliency pattern for the content item using a saliency model;
determining a loss based on applying a discriminator network to the preliminary attention pattern from the generator network and the saliency pattern from the saliency model; and
updating parameters of the generator network based on the loss.

6. The computer-implemented method of claim 1, wherein the features extracted from the plurality of content components include a first embedding for a first content component generated by a first feature extractor and a second embedding for a second content component generated by a second feature extractor.

7. The computer-implemented method of claim 6, wherein the method further comprises:
concatenating the first embedding and the second embedding to provide a concatenated embedding; and
providing the concatenated embedding as input to the cross-modal attention encoder to generate the embedding of the content item.

8. The computer-implemented method of claim 1, wherein the method further comprises:
determining a topic by applying a topic classifier to output from a topic attention layer of the cross-modal attention encoder; and
wherein the decoder uses the topic to generate the action-reason statement.

9. The computer-implemented method of claim 1, wherein the method further comprises:
determining a sentiment by applying a sentiment classifier to output from a sentiment attention layer of the cross-modal attention encoder; and
wherein the decoder uses the sentiment to generate the action-reason statement.

10. One or more computer storage media storing computer-useable instructions that, when used by a computing device, cause the computing device to perform operations, the operations comprising:
extracting, by a first feature extractor, a first embedding for a first content component of a content item;
extracting by a second feature extractor, a second embedding for a second content component of the content item, the second content component in a second modality different from a first modality of the first content component;
determining, using a cross-modal attention encoder, an embedding of the content item using the first embedding and the second embedding; and
generating, by a decoder, an action-reason statement using the embedding of the content item.

11. The one or more computer storage media of claim 10, wherein the first content component comprises one or more selected from the following, an image of the content item, an image object, a caption, a symbol, and text.

12. The one or more computer storage media of claim 10, wherein the first content component comprises an image of the content item, and wherein extracting features from the first content component comprises generating an attention pattern for the content item using a generator network trained using adversarial training.

13. The one or more computer storage media of claim 12, wherein the generator network is trained by:
generating a preliminary attention pattern for the content item using the generator network;
generation a saliency pattern for the content item using a saliency model;
determining a loss based on applying a discriminator network to the preliminary attention pattern from the generator network and the saliency pattern from the saliency model; and
updating parameters of the generator network based on the loss.

14. The one or more computer storage media of claim 10, wherein the operations further comprise:
determining a topic by applying a topic classifier to output from a topic attention layer of the cross-modal attention encoder; and
wherein the decoder uses the topic to generate the action-reason statement.

15. The one or more computer storage media of claim 10, wherein the operations further comprise:
determining a sentiment by applying a sentiment classifier to output from a sentiment attention layer of the cross-modal attention encoder; and
wherein the decoder uses the sentiment to generate the action-reason statement.

16. A computer system comprising:
a processor; and
a computer storage medium storing computer-useable instructions that, when used by the processor, causes the computer system to perform operations comprising:
generating, by an attention pattern module, an attention pattern for a content item;
determining, by a feature extraction module, a first embedding based on the attention pattern;
determining, by the feature extraction module, a second embedding based on a content component of the content item;
determining, using a cross-modal attention encoder, an embedding of the content item using the first embedding and the second embedding; and
generating, by a decoder, an action-reason statement using the embedding of the content item.

17. The computer system of claim 16, wherein the content component comprises one or more selected from the following, an image object, a caption, a symbol, and text.

18. The computer system of claim 16, wherein the attention pattern module comprises a generator network trained by:
generating a preliminary attention pattern for the content item using the generator network;
generation a saliency pattern for the content item using a saliency model;
determining a loss based on applying a discriminator network to the preliminary attention pattern from the generator network and the saliency pattern from the saliency model; and
updating parameters of the generator network based on the loss.

19. The computer system of claim 16, wherein the operations further comprise:
determining a topic by applying a topic classifier to output from a topic attention layer of the cross-modal attention encoder; and
wherein the decoder uses the topic to generate the action-reason statement.

20. The computer system of claim 16, wherein the operations further comprise:
determining a sentiment by applying a sentiment classifier to output from a sentiment attention layer of the cross-modal attention encoder; and
wherein the decoder uses the sentiment to generate the action-reason statement.
